(19) United States
(12) Patent Application Publication
(10) Pub. No.: US 2024/0204937 A1
(43) Pub. Date: Jun. 20, 2024

(54) METHODS, DEVICES, AND SYSTEMS FOR MAPPING MULTIPLE TRANSPORT BLOCKS IN TIME DOMAIN

(71) Applicant: ZTE Corporation, Shenzhen (CN)

(72) Inventors: Yan XUE, Shenzhen (CN); Feng XIE, Shenzhen (CN); Hanchao LIU, Shenzhen (CN); Fei WANG, Shenzhen (CN); Jun XU, Shenzhen (CN)

(73) Assignee: ZTE Corporation, Shenzhen (CN)

(21) Appl. No.: 18/593,459

(22) Filed: Mar. 1, 2024

Related U.S. Application Data
(63) Continuation of application No. PCT/CN2021/123015, filed on Oct. 11, 2021.

(51) Int. Cl. H04L 5/00; H04L 1/1812

(52) U.S. Cl. CPC H04L 5/0016; H04L 1/1812; H04L 5/0055

(57) ABSTRACT

The present disclosure describes methods, system, and devices for mapping multiple transport blocks (TBs) in a time domain. The method includes transmitting a set of transport blocks (TBs) between a first wireless device and a second wireless device by: mapping the set of TBs in a resource space comprising a time unit in a time domain and a frequency unit in a frequency domain, wherein: each TB mapped to a same codeword in the set of TBs is separated in time domain; the set of TBs comprises n TBs mapped to the same codeword, and n is an integer larger than 1; and each TB in the set of TBs is capable of being packaged separately at a transmitting end, and capable of being delivered separately to an upper layer at a receiving end.

### TECHNICAL FIELD

The present disclosure is directed generally to wireless communications. Particularly, the present disclosure relates to methods, devices, and systems for mapping multiple transport blocks (TBs) in a time domain.

### BACKGROUND

Wireless communication technologies are moving the world toward an increasingly connected and networked society. High-speed and low-latency wireless communications rely on efficient network resource management and allocation among one or more user equipment and one or more wireless access network nodes (including but not limited to base stations). A new generation network is expected to provide high speed, low latency and ultra-reliable communication capabilities and fulfill the requirements from different industries and users.

With the rapid evolution of cellular mobile communication systems, more and more applications emerge in various businesses and/or service industries. Some services, such as holographic communication, industrial internet traffic and immersive cloud extended reality (XR), need to meet both ultra-high throughput and ultra-low latency simultaneously. This type of services integrates the characteristics of the two scenarios of high performance and high efficiency wireless networks: extremely high requirements for throughput, but also high requirements for low latency. There are problems or issues associated with the present wireless communication technology, and it is difficult to meet the reliable transmission of data at a large volume under low-latency requirements. One of the problems/issues is that it may be difficult to achieve differential transmission of symbols in a time domain for multiple TBs, when transmitted data may have differential priority requirement.

The present disclosure describes various embodiments for mapping multiple transport blocks (TBs) in a time domain, addressing at least one of the problems/issues discussed above. The various embodiments in the present disclosure may enhance performance of enhanced mobile broadband (eMBB) and/or ultra reliable low latency communication (URLLC) and/or provide new scenarios requiring large bandwidth and low latency, improving a technology field in the wireless communication.

### SUMMARY

This document relates to methods, systems, and devices for wireless communication, and more specifically, for mapping multiple transport blocks (TBs) in a time domain.

In one embodiment, the present disclosure describes a method for wireless communication. The method includes transmitting a set of transport blocks (TBs) between a first wireless device and a second wireless device by: mapping the set of TBs in a resource space comprising a time unit in a time domain and a frequency unit in a frequency domain, wherein: each TB mapped to a same codeword in the set of TBs is separated in time domain; the set of TBs comprises n TBs mapped to the same codeword, and n is an integer larger than 1; and each TB in the set of TBs is capable of being packaged separately at a transmitting end, and capable of being delivered separately to an upper layer at a receiving end.

In another embodiment, the present disclosure describes a method for wireless communication. The method includes receiving, by a second wireless device, a higher layer message carrying a radio configuration information of a set of TBs, wherein: the set of TBs comprises n TBs mapped to a same codeword, and n is an integer larger than 1, the set of TBs is mapped in a resource space comprising a time unit in a time domain and a frequency unit in a frequency domain, each TB mapped to the same codeword in the set of TBs is separated in time domain, and each TB in the set of TBs is capable of being packaged separately at a transmitting end, and capable of being delivered separately to an upper layer at a receiving end; and in response to receiving the higher layer message, operating, by the second wireless device according to the radio configuration information of the set of TBs.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1 shows an example of a wireless communication system include a core network, a first wireless device, a second wireless device, a third wireless device, and a fourth wireless device.

FIG. 2 shows an example of a wireless network node.

FIG. 3 shows an example of a user equipment.

FIG. 4 shows a flow diagram of a method for wireless communication.

FIG. 5 shows a flow diagram of a method for wireless communication.

FIG. 6A shows a schematic diagram of an embodiment in the present disclosure for wireless communication.

FIG. 6B shows a schematic diagram of an embodiment in the present disclosure for wireless communication.

FIG. 6C shows a schematic diagram of an embodiment in the present disclosure for wireless communication.

FIG. 7 shows a schematic diagram of an embodiment in the present disclosure for wireless communication.

FIG. 8 shows a schematic diagram of an embodiment in the present disclosure for wireless communication.

FIG. 9 shows a schematic diagram of an embodiment in the present disclosure for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes various methods and devices for mapping multiple transport blocks (TBs) in a time domain.

New generation (NG) mobile communication system are moving the world toward an increasingly connected and networked society. High-speed and low-latency wireless communications rely on efficient network resource management and allocation among one or more user equipment and one or more wireless access network nodes (including but not limited to wireless base stations). A new generation network is expected to provide high speed, low latency and ultra-reliable communication capabilities and fulfill the requirements from different industries and users.

With the rapid evolution of cellular mobile communication systems, more and more applications emerge in various businesses and/or service industries. Some services, such as holographic communication, industrial internet traffic and extended reality (XR), need to meet both ultra-high throughput and ultra-low latency. This type of services integrates the characteristics of the two scenarios of high performance and high efficiency wireless networks: extremely high requirements for throughput, but also high requirements for low latency. For example but not limited, the large bandwidth, high throughput, and low latency scenarios may need the reliable transmission of data at a large volume under low-latency requirements.

In a 4G and/or a 5G system, on a baseband carrier (e.g., also called a single cell), each transport block (TB) may be scheduled for transmission on a baseband carrier with a transmission time interval (TTI) as a basic time-domain scheduling unit. Each hybrid automatic repeat request (HARQ) process may be in a TTI. A TB is called a codeword after channel coding process. In the spatial multiplexing transmission, there are up to two codewords, which is called the first codeword and the second codeword according to the layer mapping configuration. A codeword may be mapped to all or part of the layers. Multiple different data streams can be transmitted on different layers simultaneously. After using the spatial multiplexing technology, a UE may be allowed to transmit one TB on a carrier and a HARQ process in response to a single codeword transmission; and/or a UE may be allowed to simultaneously transmit two TBs on a carrier and a HARQ process in response to a two codeword transmission. In other words, for the same user, no more than two TBs may be scheduled in a time-domain transmission unit. In order to increase the throughput, one way is to increase the number of bits contained in a TB, that is, to expand the TB Size (TBS). However, considering factors such as coding and interleaving gain, the TB size is limited. For example, in long term evolution (LTE), a TBS may be required to be no greater than 6144 bits. In response to a TB being larger than 6144 bits, this TB may be divided into multiple code blocks (Code Block, CB) for encoding and transmission.

In various embodiments, each TB may include a cyclical redundancy check (CRC), and each CB in each TB may also include a CRC. When the CRC check of a certain CB fails, only this CB may need to be retransmitted, and the entire TB may not need to be retransmitted.

In some implementations in a 5G new radio (NR), in order to reduce the feedback overhead of CB transmission, a code block group (CBG) method may be used for feedback, that is, multiple CBs may be used as a group to use 1 bit for acknowledgement/negative acknowledgement (ACK/NACK) feedback. One of the issues associated with this approach may be that, when a CB is unsuccessful in transmission, the entire CBG where the wrong CB is located must be retransmitted. Only when the CRC check of all CBs and the CRC check of the entire TB pass, the TB transmission may be considered successful. After using code block segmentation, as the number of CBs and CBGs increases, the supported TBS may increase as well. Because each CB needs a CRC check, the larger the TB, the higher the possibility of CB transmission failure. CB transmission failure may result in CB retransmission. As long as there is a CB transmission failure in the TB, it may be retransmitted and waited. After all the CB transmissions are successful and the CRC of the CB level and the TB level are both verified, the TB may be delivered to the upper layer. One of the issues/problems with this approach is that the more CB and CBG, the longer the waiting time may be. For services with high latency requirements, such as live video services, data packets must be transmitted correctly within a certain period of time. When it times out, even the transmission is correct, it will be considered unsatisfactory and discarded. Thus, the existing technology may be difficult to meet the requirements of high throughput and low latency at the same time. The larger the TBS, the greater the transmission delay; and the smaller the TBS, the lower the throughput. In traffic transmission, different packets transmitted at the same time may have different delay requirements. The one or more packets with time sensitive requirements, such as packets of control type and live video type, must be transmitted correctly within a certain time, and need to be transmitted earlier with high priority. Some packets with time nonsensitive requirements may be transmitted later with low priority. In the current technology, a TB is transmitted on all symbols of a TTI, so it is difficult to realize the differential transmission of data in time domain.

One of the issues/problems associated with some of the above approaches may be that, for large bandwidth scenarios, even when frequency domain resources are sufficiently available, the differentiation data transmission in the time domain may be difficult to achieve simultaneously.

There are problems or issues associated with the present wireless communication technology, and it is difficult to meet the differentiation data transmission in the time domain at high throughput under different low-latency requirements. One of the problems/issues is that it may be difficult to achieve differential transmission of symbols in a time domain for multiple TBs, when transmitted data may have differential priority requirement.

The present disclosure describes various embodiments for mapping multiple transport blocks (TBs) in a time domain, addressing at least one of the problems/issues discussed above. The present disclosure may enhance performance of enhanced mobile broadband (eMBB) and/or ultra reliable low latency communication (URLLC), improving a technology field in the wireless communication.

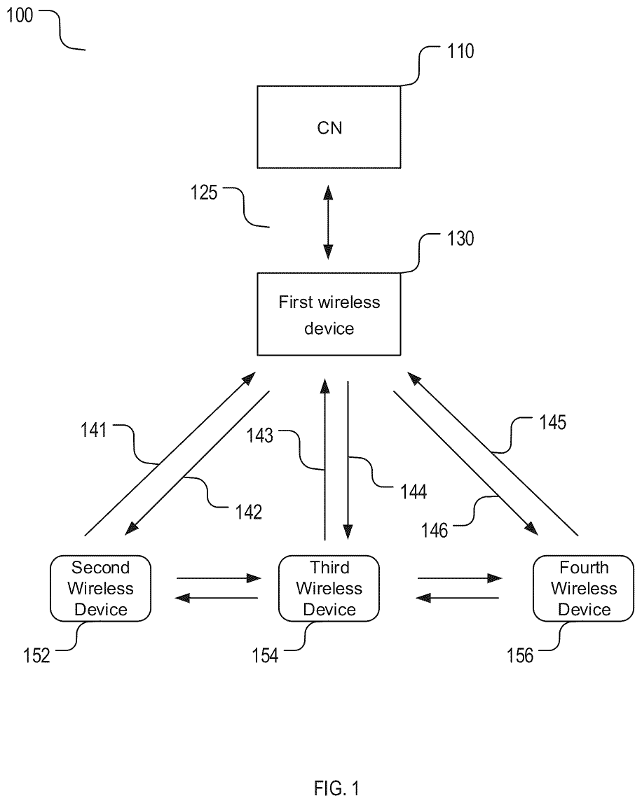

FIG. 1 shows a wireless communication system 100 including a portion or all of the following: a core network (CN) 110, a first wireless device 130, a second wireless device 152, a third wireless device 154, and a fourth wireless device 156. There may be wireless communication between any two of the first wireless device, the second wireless device, the third wireless device, and the third wireless device.

The first wireless device may include one of the following: a base station; a MAC layer in a wireless device; a scheduling unit; a user equipment (UE); an on-board unit (OBU); a road-side unit (RSU); or an integrated access and backhaul (IAB) node.

The second wireless device, the third wireless device, or the third wireless device may include one of the following: a user equipment (UE); or an integrated access and backhaul (IAB) node.

In various embodiments, the first wireless device 130 may include a wireless node. The second wireless device, the third wireless device, and/or the third wireless device may include one or more user equipment (UE) (152, 154, and 156). The wireless node 130 may include a wireless network base station, a radio access network (RAN) node, or a NG radio access network (NG-RAN) base station or node, which may include a nodeB (NB, e.g., a gNB) in a mobile telecommunications context. In one implementation, the core network 110 may include a 5G core network (5GC or 5GCN), and the interface 125 may include a NG interface. The wireless node 130 (e.g, RAN) may include an architecture of separating a central unit (CU) and one or more distributed units (DUs). In another implementation, wireless network may include a 6G network or any future generation network.

The communication between the RAN and the one or more UE may include at least one radio bearer or channel (radio bearer/channel). Referring to FIG. 1, a first UE 152 may wirelessly receive from the RAN 130 via a downlink radio bearer/channel 142 and wirelessly send communication to the RAN 130 via a uplink radio bearer/channel 141. Likewise, a second UE 154 may wirelessly receive communicate from the RAN 130 via a downlink radio bearer/channel 144 and wirelessly send communication to the RAN 130 via a uplink radio bearer/channel 143; and a third UE 156 may wirelessly receive communicate from the RAN 130 via a downlink radio bearer/channel 146 and wirelessly send communication to the RAN 130 via a uplink radio bearer/channel 145.

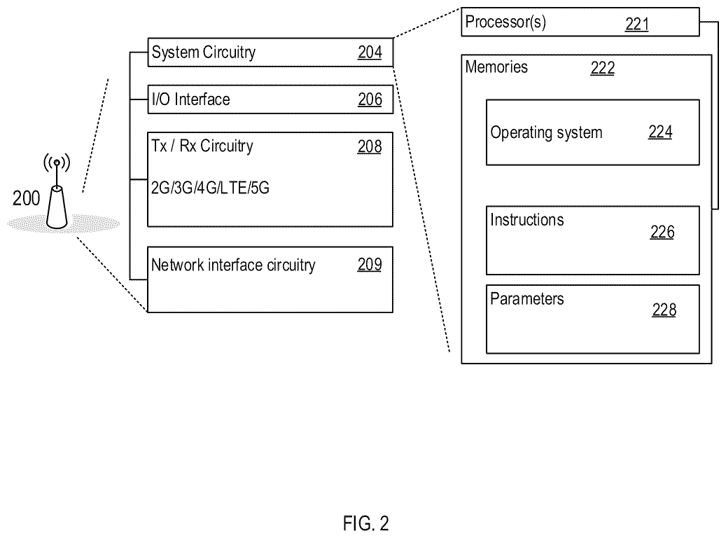

FIG. 2 shows an example of electronic device 200 to implement a network base station (e.g., a radio access network node), a core network (CN), and/or an IAB node. Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

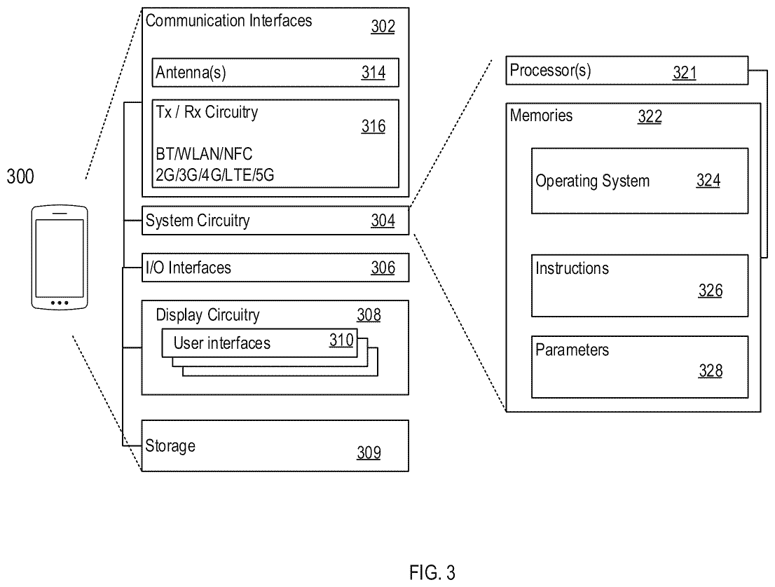

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G, 6G, or any future generation communication. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes various embodiments for mapping multiple transport blocks (TBs) in a time domain, which may be implemented, partly or totally, on one or more electronic device 200 and/or one or more terminal device 300 described above in FIGS. 2-3. Various embodiments includes transmission method for mapping multiple TBs in the time domain on a single HARQ process, solving at least one of the problems in achieving large bandwidth, large throughput and different latency transmission.

Various embodiments in the present disclosure may at least solve the issues of differential data transmission according to different time domain position of the transmitted data, achieving different latency for the wireless transmission.

In various embodiments, a receiving end does not need to wait for a completion of receiving all TBs in the TTI, achieving independent/individual receipt or feedback for each TB in the TTI, leading to different latency for the wireless transmission.

In various embodiments, the description may be described with a single (or one) codeword transmission on a single carrier as examples, and a two codeword transmission may be applicable as well for at least some of the various embodiments.

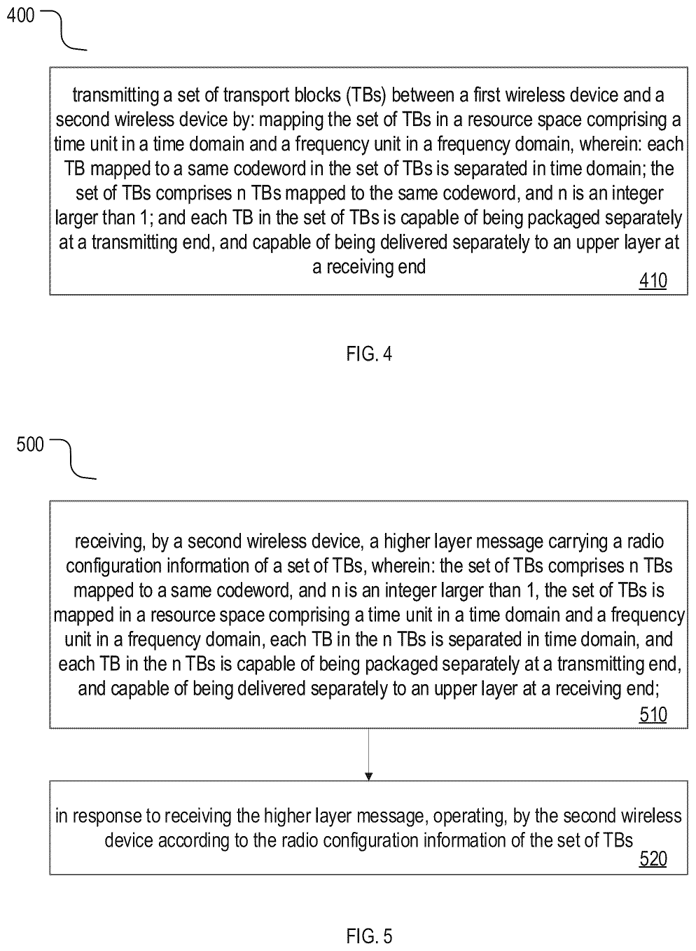

In various embodiment, referring to FIG. 4, a method 400 for wireless communication includes transmitting a set of transport blocks (TBs) between a first wireless device and a second wireless device. The method 400 may include step 410, transmitting a set of transport blocks (TBs) between a first wireless device and a second wireless device by: mapping the set of TBs in a resource space comprising a time unit in a time domain and a frequency unit in a frequency domain, wherein: each TB mapped to a same codeword in the set of TBs is separated in time domain; the set of TBs comprises n TBs mapped to the same codeword, and n is an integer larger than 1; and each TB in the set of TBs is capable of being packaged separately at a transmitting end, and capable of being delivered separately to an upper layer at a receiving end.

In some implementations, the resource space corresponds to the set of TBs in a hybrid automatic repeat request (HARQ) process in a carrier.

In some other implementations, each TB in the set of TBs corresponds to a media access control (MAC) protocol data unit (PDU).

In some other implementations, the time unit comprises at least one of the following: a transmission time interval (TTI), a slot, a sub-frame, or a mini slot.

In some other implementations, the frequency unit comprises at least one of the following: a subcarrier, a resource block (RB), a subband, a bandwidth part (BWP), or a carrier.

In some other implementations, the same codeword comprises at least one of the following: a first codeword, or a second codeword.

In some other implementations, the first wireless device is configured to schedule transmission of the set of TBs, and the first wireless device comprises at least one of the following: a base station; a MAC layer in a wireless device; a scheduling unit; a user equipment (UE); an on-board unit (OBU); a road-side unit (RSU); or an integrated access and backhaul (IAB) node.

In some other implementations, the second wireless device is configured to receive transmission of the set of TBs, and the second wireless device comprises at least one of the following: a user equipment (UE); or an integrated access and backhaul (IAB) node.

In some other implementations, the first wireless device determines a transport block size (TBS) of each TB in the n TBs by: determining, based on a channel state information, a resource space for the set of TBs, a modulation coding scheme (MCS) for the n TBs, a number of layers for the n TBs; determining a number of symbol in the time domain of each TB in the n TBs based on a mapping rule; determining a number of REs for each TB in the n TBs based on the resource space for the set of TBs and the number of symbols in the time domain; and determining the TBS of each TB in the n TBs based on the number of REs for each TB in the n TBs, the modulation coding scheme (MCS) for the n TBs, the number of layers for the n TBs.

In some other implementations, the mapping rule comprises at least one of the following: a mapping pattern of TB to symbol in the time domain; a number of symbols in the time domain for each TB; a mapping relationship of TB index to symbol index, or mapping a TB corresponding to the second codeword according to the mapping rule of the TB corresponding to the first codeword in same time-frequency resource.

In some other implementations, the mapping pattern of TB to symbol in the time domain may include indicate a symbol position for each TB in the time domain. In some other implementations, the number of symbols in the time domain for each TB may include that, for each TB, there are a fixed value for example two symbols in the time domain corresponding to each TB. In some other implementations, the mapping relationship of TB index to symbol index may indicate which symbols in time domain corresponding to each TB. In some other implementations, the two TBs in same time-frequency resource corresponding to the two codeword, after one TB corresponding to the first codeword is determined the mapping relation with symbols, the TB corresponding to the second codeword use the same mapping relation with symbols. That is, the two TBs in same time-frequency resource is mapped to the same symbol.

In some other implementations, the method 400 may further include sending, by the first wireless device to the second wireless device, control information corresponding to resource allocation of the set of TBs, wherein the control information comprises at least one of the following: a resource space in a time-frequency domain for the set of TBs; a resource indication in a frequency domain for the set of TBs; a resource indication in a time domain for the set of TBs; a mapping rule; an MCS for the n TBs; spatial multiplexing information related to a number of layers for the n TBs; power control information for the n TBs; an identification (ID) number for the n TBs; a resource mapping configuration for the n TBs; a number of TBs in the n TBs; a symbol position information in the time domain for each TB in the n TBs; or a frequency position information in the frequency domain for each TB in the n TBs.

In some other implementations, the second wireless device determines a transport block size (TBS) of each TB in the n TBs by: receiving the control information corresponding to the resource allocation of the set of TBs; determining, in a HARQ process, a number of resource elements (REs) for each TB, a modulation coding scheme (MCS) for the n TBs, a number of layers for the n TBs; and determining the TBS of each TB in the n TBs based on the number of resource elements (REs) for each TB, the modulation coding scheme (MCS), the number of layers.

In some other implementations, the mapping rule comprises at least one of the following: a mapping pattern of TB to symbol in the time domain; a number of symbols in the time domain for each TB; a mapping relationship of TB index to symbol index, or mapping a TB corresponding to the second codeword according to the mapping rule of the TB corresponding to the first codeword in same time-frequency resource.

In some other implementations, the control information is transmitted via at least one of the following: a downlink control information (DCI), a radio resource control (RRC) signaling, a high layer signaling, a MAC control element (CE), or system information.

In some other implementations, upon receiving all time-domain symbols of a TB in the n TBs, the second wireless device performs a TB level process on the all time-domain symbols without waiting for receiving any other TB in the n TBs, wherein the TB level process comprises at least one of the following: a de-mapping process, a de-interleaving process, a de-modulating process, a de-coding process, or a process of delivering to a upper layer.

In some other implementations, the method 400 may further include receiving, by the second wireless device, the control information from the first wireless device; processing, by the second wireless device, the set of TBs based on the control information by at least one of the following: receiving data from the first wireless device based on the control information from the first wireless device; sending data to the first wireless device based on the control information from the first wireless device; sending data to a third wireless device based on the control information from the first wireless device; or receiving data from the third wireless device based on the control information from the first wireless device.

In some other implementations, the third wireless device is configured to receive or send transmission of the set of TBs, and the third wireless device comprises at least one of the following: a user equipment (UE); or an integrated access and backhaul (IAB) node.

In some other implementations, the method 400 may further include in response to receiving the data from the first wireless device, sending, by the second wireless device, feedback information to the first wireless device by at least one of the following: sending the feedback information separately for each TB in the n TBs; sending the feedback information together for the n TBs; sending the feedback information for each code block (CB) in the n TBs; or sending the feedback information for each code block group (CBG) in the n TBs.

In some other implementations, the method 400 may further include in response to receiving the data from the second wireless device, sending, by the third wireless device, feedback information to the first wireless device via the second wireless device by at least one of the following: sending the feedback information separately for each TB in the n TBs; sending the feedback information together for the n TBs; sending the feedback information for each code block (CB) in the n TBs; or sending the feedback information for each code block group (CBG) in the n TBs.

In some other implementations, the method 400 may further include in response to the feedback information being same for each TB in the n TBs, sending the feedback information comprising a feedback indication for the n TBs, wherein: in response to each TB in the n TBs being received successfully, the feedback information comprises an acknowledgement (ACK) indication indicating each TB in the n TBs being received successfully; and in response to each TB in the n TBs being received unsuccessfully, the feedback information comprises a NAK indication indicating each TB in the n TBs being received unsuccessfully.

In one embodiment, referring to FIG. 5, a method 500 for wireless communication. The method 500 may include a portion or all of the following steps: step 510, receiving, by a second wireless device, a higher layer message carrying a radio configuration information of a set of TBs, wherein: the set of TBs comprises n TBs mapped to a same codeword, and n is an integer larger than 1, the set of TBs is mapped in a resource space comprising a time unit in a time domain and a frequency unit in a frequency domain, each TB in the n TBs is separated in time domain, and each TB in the n TBs is capable of being packaged separately at a transmitting end, and capable of being delivered separately to an upper layer at a receiving end; and step 520, in response to receiving the higher layer message, operating, by the second wireless device according to the radio configuration information of the set of TBs.

In some implementations, the higher layer message is at least one of the following: a layer 3 (L3) layer message, or a radio resource control (RRC) message.

In some other implementations, the radio configuration information comprises at least one of the following: a value of n, or a resource mapping rule.

In some other implementations, the resource space corresponds to the set of TBs in a hybrid automatic repeat request (HARQ) process in a carrier.

In some other implementations, each TB in the set of TBs corresponds to a media access control (MAC) protocol data unit (PDU).

In some other implementations, the time unit comprises at least one of the following: a transmission time interval (TTI), a slot, a sub-frame, or a mini slot.

In some other implementations, the frequency unit comprises at least one of the following: a subcarrier, a resource block (RB), a subband, a bandwidth part (BWP), or a carrier.

In some other implementations, the same codeword comprises at least one of the following: a first codeword, or a second codeword.

In some other implementations, a mapping rule of the n TBs for a resource comprises at least one of the following: a mapping pattern of TB to symbol in the time domain; a number of symbols in the time domain for each TB; a mapping relationship of TB index to symbol index, or mapping a TB corresponding to the second codeword according to the mapping rule of the TB corresponding to the first codeword in same time-frequency resource.

For some implementations with a 5G system, one TB may be transmitted in one TTI, and an entire TB needs to be correctly received in the TTI before it may be delivered to a upper layer.

In various embodiments in the present disclosure, transmission and/or reception of TB may be realized at a symbol level, and a high priority TB (e.g., a TB requiring lower latency) may be placed in one or more earlier symbols to achieve fast transmission and reception.

The present disclosure further describes various embodiments below, which serve as examples and should not be interpreted as any limitations to the present disclosure.

### Embodiment 1: Transmission of Multiple TBs with Multiple MAC PDUs in a TTI

In the method, the nTBs in a TTI in a carrier in a HARQ process are mapped to the first codeword. Unless specifically stated, the description may be described with a single (or one) codeword transmission on a single carrier as examples. But a two codeword transmission may be applicable as well for at least some of the various embodiments.

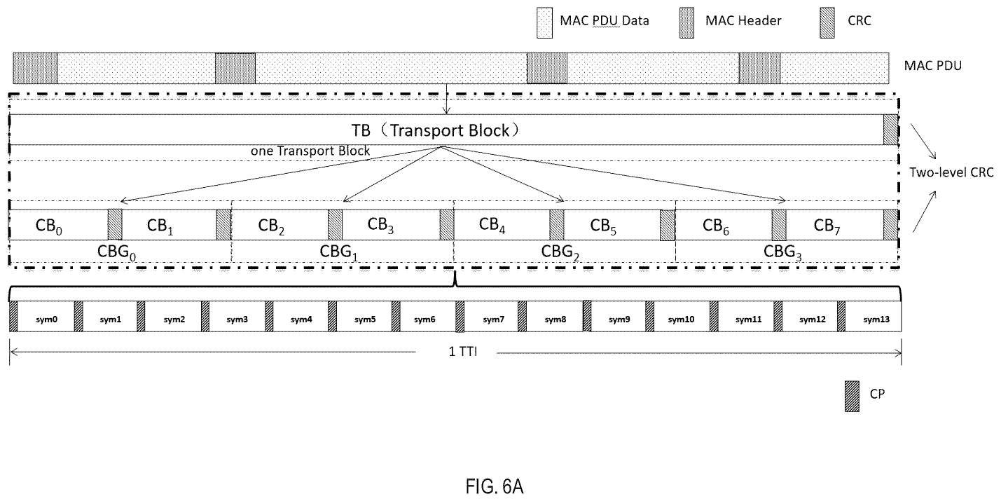

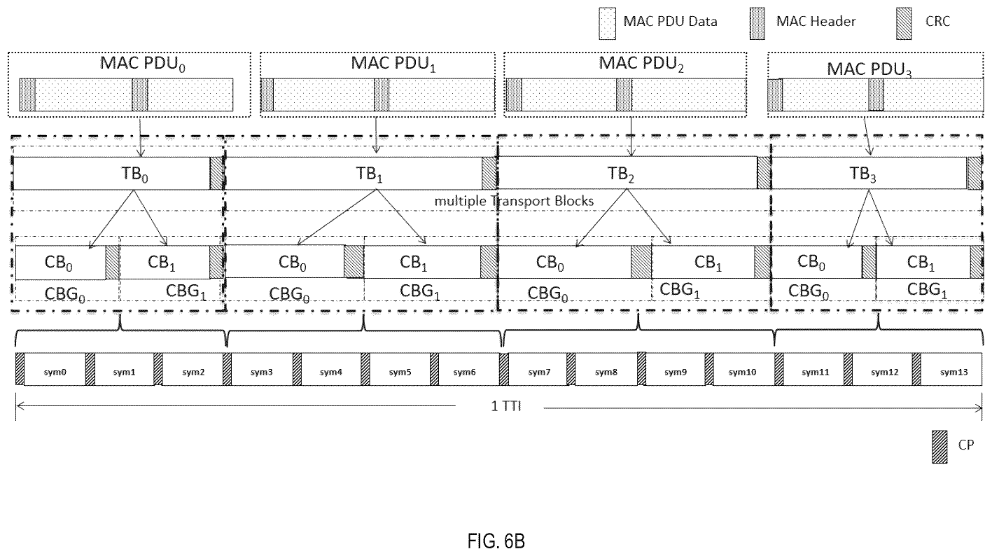

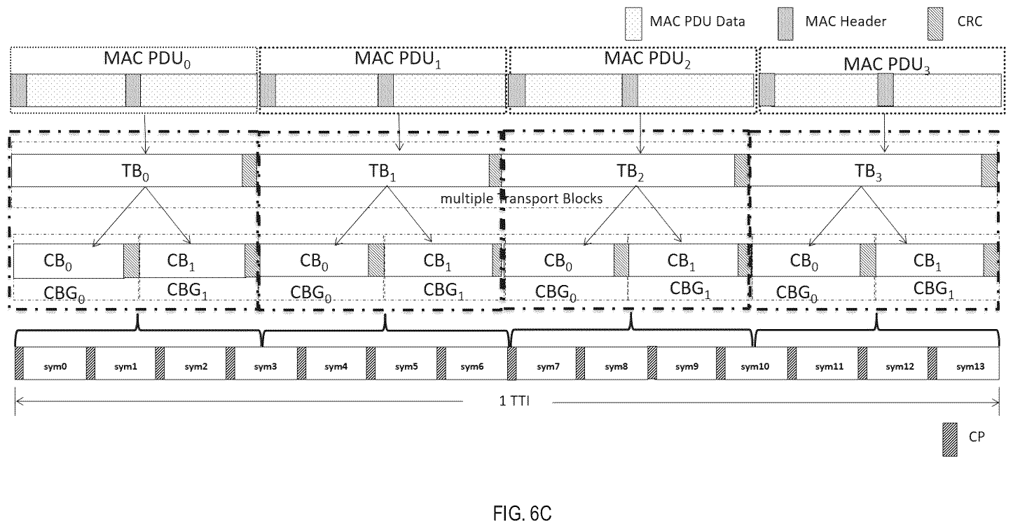

As shown in FIG. 6A, for some implementations in a 5G system, at a MAC layer, a MAC PDU may include multiple sub-PDUs, and each sub-PDU may include a sub-header and a data part. MAC PDU may be a data unit that is delivered to the physical layer after the MAC layer protocol is processed. One MAC PDU may correspond to one TB of the physical layer. At the physical layer, a TB may be divided further to form CB and CBG, which may be mapped to time-domain symbols and cyclic prefix (CP) through modulation and coding of the physical layer to form data to be transmitted in a TTI (or TTI data). In the TTI, when spatial multiplexing and multi-carrier are not considered, only one TB may be transmitted on a single carrier.

In various embodiments, one MAC PDU may correspond to one TB of the physical layer. At the physical layer, TB may still divided to form CB and CBG. In one TTI, multiple MAC PDUs may be mapped to multiple TBs, and different TBs may be transmitted corresponding to different symbols in one TTI. Multiple TBs in a TTI are mapped to different time-domain symbols according to different priorities in the time domain, and a TB that is sensitive to the delay requirement has the highest priority.

As shown in FIG. 6B, a 4 TBs (TB₀, TB₁, TB₂, and TB₃) in a TTI are transmitted in the time domain. TB₀ has the highest priority and is placed in the first 4 symbols (sym0-sym3) of a TTI for transmission. Here, the “first” 4 symbols in the TTI may refer to the “earliest” 4 symbols in the TTI. TB₁ has the second highest priority and is placed in Sym3-sym6 transmission of a TTI; TB₂, TB₃ and so on.

In some implementations, referring to FIG. 6B, the time domain symbols may be aligned with the TB boundary, that is, only 1 TB is transmitted on a time domain symbol. Optionally, the data corresponding to the TB can be aligned with the time domain symbol boundary by means of padding bits.

In some other implementations, a time domain symbol may be allowed to transmit more than 2 TBs at the same time, that is, to allow the time domain symbol to be misaligned with the TB boundary, for example, the sym3 and/or sym10 in FIG. 6C.

### Embodiment 2: Differential Transmission According to Mapping TB to Time-Domain Symbols

In a large-bandwidth scenario, frequency domain resources may be abundant, and each user may be allocated with enough bandwidth. In the method, the nTBs in a TTI in a carrier in a HARQ process are mapped to the first codeword. Unless specifically stated, the description may be described with a single (or one) codeword transmission on a single carrier as examples. But a two codeword transmission may be applicable as well for at least some of the various embodiments.

In some implementations, multiple TBs may be scheduled for transmission at the same time in a TTI, and these TBs may be mapped/scheduled with different time domain symbols according to their priorities. These implementations may achieve low-latency transmission with large bandwidth and high throughput, especially for services requiring high throughput and low latency such as XR, wherein these services are very sensitive to low latency of data transmission and need to be transmitted with ultra-low latency as much as possible. Data requiring ultra-low latency may be placed on the symbols earlier in the time domain, which enables the receiver to receive them as soon as possible and process them in time. The prioritized mapping/scheduling may have a significant effect on further reducing service latency.

Taking a single codeword stream as an example, the various implementations may include a portion or all of the following steps.

Step 2-1: A base station may schedule n TBs jointly, i.e. scheduling n TBs as a whole, wherein a same MCS, a common time-frequency domain range, and a mapping rules are allocated to n TBs on one carrier. The value of n is determined according to business requirements such as throughput and/or latency requirements. In some implementations, n may be an integer greater than 1.

Step 2-2: The base station may perform physical layer processing and mapping on each TB of the n TBs according to the scheduling results, and determines a number of time-domain symbols for each TB, and maps the TB with lower latency requirements to the earlier time-domain symbols in a TTI according to the mapping rule of the TB.

Step 2-3: The base station sends a scheduling information indication of n TBs (such as using DCI) to the UE. The scheduling information indicates the dedicated scheduling information of each TB in the n TBs, and may include at least one of the following: each TB number, a specific symbol position of each TB in the time domain, a specific position of each TB in the frequency domain. In some implementations, the scheduling information may further include the common scheduling information of n TBs, which includes at least one of the following: the same MCS, the common time-frequency domain range, the mapping rule, a TB number in n TBs. The scheduling information indication may also include dedicated scheduling information for each TB of n TBs, such as each TB number, a time domain symbol position index of each TB, a start and end positions of each TB time domain symbol, and/or a specific frequency domain index of each TB.

Step 2-4: A UE performs symbol-level reception processing of each TB according to the position of the TB in the time domain within the common time-frequency domain on the carrier according to the received scheduling information.

Step 2-5: After the UE decodes the TB, it sends feedback to the base station. The feedback may be based on each TB, based on each CB, or based on each CBG.

Step 2-6: The UE may immediately deliver the data to the MAC layer after successfully receiving a complete TB.

Because the low-latency TB is mapped/scheduled with earlier symbol in a TTI, the lower-latency TB will be received first, and fed back and delivered to the upper layer as soon as possible, without waiting for other TB data of other symbols in a TTI, which further reduces the transmission delay and processing delay. In various embodiment of the present disclosure, a time sensitive packet may be received quickly and differentiated transmission in the time-domain is realized, meeting the service requirement of different latency.

### Embodiment 3: Reducing Latency with First Receipt, First Delivery

In the method, the nTBs in a TTI in a carrier in a HARQ process are mapped to the first codeword. Unless specifically stated, the description may be described with a single (or one) codeword transmission on a single carrier as examples. But a two codeword transmission may be applicable as well for at least some of the various embodiments.

According to the scheduling instruction information of multiple TBs, a receiving end receives a first TB among the multiple TBs, wherein the first TB is received by the receiving end earlier among the multiple TBs. The receiving end may decode the first TB first/earlier; and/or may deliver the first TB to a higher layer first/earlier. The various implementation may improve the processing delay of decoding and achieves a low-latency effect.

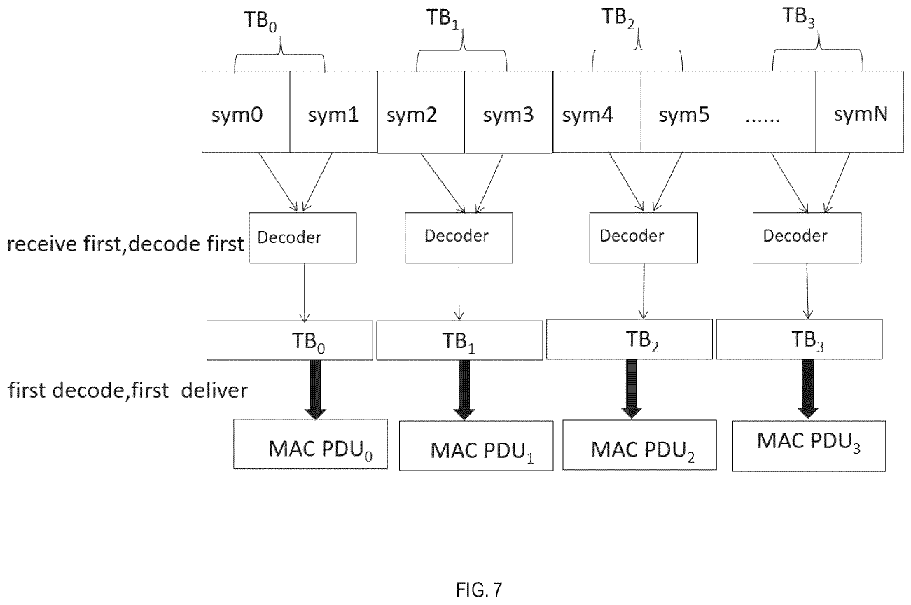

In some implementations, referring to FIG. 7, the receiving end may include one or more decoders to decode each of the multiple TBs independently according to the scheduling instructions of multiple TBs. The decoder for each TB may begin decoding right upon receiving the transmitted TB; and/or the first/earliest completion of decoding according to a TB, the first/earliest delivery/submission of the TB to a higher layer. The performance of the system may be further improved by differential transmission latency of multiple TBs, decreasing the processing delay of decoding and achieving the effect of different latency.

### Embodiment 4: Public and Dedicated Scheduling Information in DCI

In the method, the nTBs in a TTI in a carrier in a HARQ process are mapped to the first codeword. Unless specifically stated, the description may be described with a single (or one) codeword transmission on a single carrier as examples. But a two codeword transmission may be applicable as well for at least some of the various embodiments.

A base station may transmit a DCI indication to a UE for scheduling transmission of n TBs jointly or scheduling transmission of the TB group of the UE. The DCI indication may include public scheduling information and/or dedicated scheduling information.

The public (or common) scheduling information means that all TBs in the multiple TB mapped to the same codeword use the same scheduling information. The public (or common) scheduling information may include at least one of the following: an MCS, a time-frequency domain resource range, a mapping rule, a TB group number, TB information included in the multiple TB, and power control parameters, an antenna transmission mode, etc.

The base station also sends dedicated scheduling information used by each TB in the multiple TB mapped to the same codeword. The dedicated scheduling information includes at least one of the following: the TB index, the specific symbol position of the TB time domain, the start and end positions of the TB time domain symbol, the TB time domain position bitmap, and the specific position of the TB frequency domain.

### Embodiment 5: Transmission of Multiple TBs in a Two Codeword Transmission

For a 5G system, one TB corresponds one codeword. When a spatial multiplexing technology is used, a single carrier may be allowed to transmit two TBs of the user in one HARQ process in one TTI in the manner of two codeword transmission. In two codeword transmission, one TB is mapped to the first codeword, and another TB is mapped to the second codeword. The two TBs use the same time-frequency resources. But each TB has its own MCS and layer number corresponding its codeword.

In various embodiments in the present disclosure, two TBs in one HARQ process in one TTI may be transmitted in scenarios of multi-TB transmission under dual codeword stream/transmission.

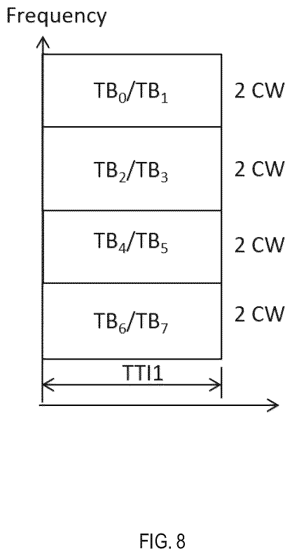

As shown in FIG. 8, in a single carrier and in one HARQ process, a UE may achieve 8 TB transmission in a two codeword transmission within a TTI, while a 5G system in previous technology may only achieve 2 TB transmission under the same circumstances.

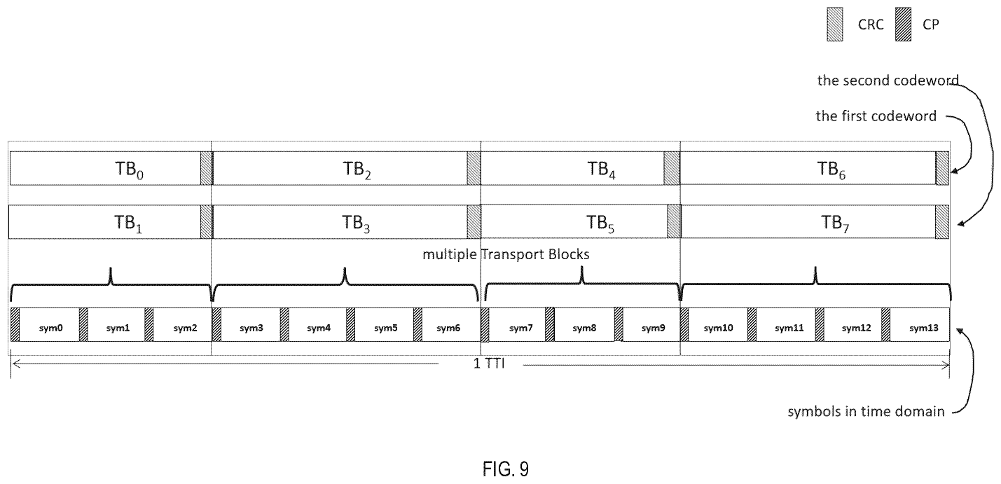

As shown in FIG. 8, for example, TB₀ and TB₁ corresponding two codeword is in the same time-frequency resource. TB₀ corresponds the first codeword. TB₁ corresponds the second codeword. There are 4 TBs (TB₀, TB₂, TB₄, TB₆) in the first codeword in one TTI, and 4 TBs (TB₁, TB₃, TB₅, TB₇) in the second codeword in the same one TTI. The 4 TBs of TB₀, TB₂, TB₄, and TB₆ use the same MCS and spatial multiplexing layer mapping (the same layer number). The 4 TBs of TB₁, TB₃, TB₅, and TB₇ use the same MCS and spatial multiplexing layer mapping (the same layer number). For example, As shown in FIG. 9, according to the mapping rule, the TB0 is mapped to sym0-sym2, the TB₁ is mapped to sym0-sym2 too.

### Embodiment 6: Configuration of n and Mapping Policy for Multiple TBs Via RRC Signaling

For multi-TB transmission in a TTI and in a single HARQ process on a single carrier, a network side, for example a base station, may send configuration information to a terminal via RRC signaling. The terminal may receive the RRC configuration message. The configuration information may include at least one of a value of n in same codeword transmission or mapping rule for a set of TBs.

For example, the network side may initiate the RRC reconfiguration process, and the RRC configuration information includes fields corresponding to transmission of multiple TBs. The fields in the configuration information may include the total number n of TBs in the same codeword transmission in multiple TBs transmission and/or resource mapping rule for the multiple TBs. The UE may receive the RRC reconfiguration message. When the RRC reconfiguration message contains a transmission field for multiple TBs, the lower layer configuration of multi-TB is performed.

In some implementations, n is an integer greater than 1, and each TB of the n TBs may be independently packaged at the transmitting end, and may be independently delivered to the upper layer at the receiving end. TB resource mapping policy may correspond to a TB mapping strategy wherein each TB in multiple TBs may be mapped to a different time-frequency resource.

### Embodiment 7: Calculation of TB Size for Multiple TBs in a HARQ Process

In the method, the nTBs in a TTI in a carrier in a HARQ process are mapped to the first codeword. Unless specifically stated, the description may be described with a single (or one) codeword transmission on a single carrier as examples. But a two codeword transmission may be applicable as well for at least some of the various embodiments.

The receiving side, for example a UE (UE1) in single codeword transmission, may receive transmissions of multiple TBs in a HARQ process.

Upon receiving scheduling control information (for example, a DCI signal), the UE1 may perform, according to the indication of the scheduling control information, reception processing on n TBs within a common time-frequency domain on a carrier on a HARQ process. the scheduling control information including a mapping rule, an MCS for n TBs and layer mapping information(for example, the number of layers for nTB). According to the scheduling control information, the receiving side may obtain which symbols corresponding one TB from a mapping rule to calculate the REs of one TB. The receiving side can infer a number of resource elements (REs) of one TB according symbol position and symbol number of the TB. The method for determining a TB size (TBS) of TB may include a portion or all of the following steps.

Step 7-1: A UE may determine which symbols corresponding a TB according to the scheduling control information.

Step 7-2: The UE may determine a number of resource elements (REs) for the TB in a time-frequency domain in a HARQ process.

Step 7-3: The UE may calculate a TB size of the TB according to the number of REs for the TB, a same MCS for n TBs and a same number of layers for n TBs.

### Embodiment 8: In Semi-Persistent Scheduling (SPS): Same Scheduling Information for a Period of Time

In a semi-persistent scheduling (SPS), a base station may use a same scheduling information to perform simultaneous scheduling and transmission of multiple TBs of a single HARQ process within a period of time, thereby reducing overhead to indicate the scheduling information.

In the SPS scheduling scenario, the base station may determine that a single carrier transmits multiple TB scheduling information for a single HARQ process on a TTI. For example, in a period of time, which may be relatively long, a number and a size of TBs in a single HARQ process may remain unchanged, an MCS may remain unchanged, and/or a TB time-frequency resource location may remain unchanged.

### Embodiment 9: Device-to-Device (D2D) Scenario

In a device-to-device (D2D) scenario, a base station may determine the scheduling information of a UE (for example, UE1). The UE1 may send multiple TB data to another UE (for example UE2) in one HARQ process according to the multi-TB scheduling information of a single HARQ process determined by the base station. The UE2 may send feedback to the base station after receiving the data. The embodiment may be applicable to other scenarios, for example but not limited to, integrated access and backhaul (IAB).

The present disclosure describes methods, apparatus, and computer-readable medium for wireless communication. The present disclosure addressed the issues with mapping multiple transport blocks (TBs) in a time domain. The methods, devices, and computer-readable medium described in the present disclosure may facilitate the performance of wireless communication by mapping multiple TBs in a time domain, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
transmitting a set of transport blocks (TBs) between a first wireless device and a second wireless device by:
mapping the set of TBs in a resource space comprising a time unit in a time domain and a frequency unit in a frequency domain, wherein:
each TB mapped to a same codeword in the set of TBs is separated in time domain;
the set of TBs comprises n TBs mapped to the same codeword, and n is an integer larger than 1; and
each TB in the set of TBs is capable of being packaged separately at a transmitting end, and capable of being delivered separately to an upper layer at a receiving end.

2. The method according to claim 1, wherein:
the resource space corresponds to the set of TBs in a hybrid automatic repeat request (HARQ) process in a carrier.

3. The method according to claim 1, wherein:
each TB in the set of TBs corresponds to a media access control (MAC) protocol data unit (PDU).

4. The method according to claim 1, wherein:
the time unit comprises at least one of the following:
a transmission time interval (TTI),
a slot,
a sub-frame, or
a mini slot.

5. The method according to claim 1, wherein:
the frequency unit comprises at least one of the following:
a subcarrier,
a resource block (RB),
a subband,
a bandwidth part (BWP), or
a carrier.

6. The method according to claim 1, wherein the same codeword comprises at least one of the following: a first codeword, or a second codeword.

7. (canceled)

8. (canceled)

9. The method according to claim 1, further including:
receiving, by the second wireless device, control information corresponding to resource allocation of the set of TBs from the first wireless device, wherein the control information comprises at least one of the following:
a resource space in a time-frequency domain for the n TBs;
a resource indication in a frequency domain for the n TBs;
a resource indication in a time domain for the n TBs;
a mapping rule;
an MCS for the n TBs;
spatial multiplexing information related to a number of layers for the set of TBs;
power control information for the set of TBs;
an identification (ID) number for the n TBs;
a resource mapping configuration for the n TBs;
a number of TBs in the n TBs;
a symbol position information in the time domain for each TB in the n TBs; or
a frequency position information in the frequency domain for each TB in the n TBs.

10. The method according to claim 9, wherein:
the second wireless device determines a transport block size (TBS) of each TB in the n TBs by:
receiving the control information corresponding to the resource allocation of the n TBs;
determining, in a HARQ process, a number of resource elements (REs) for each TB, a modulation coding scheme (MCS), a number of layers; and
determining the TBS of each TB in the n TBs based on the number of resource elements (REs) for each TB, the modulation coding scheme (MCS), the number of layers.

11. The method according to claim 9, wherein:
the mapping rule comprises at least one of the following:
a mapping pattern of TB to symbol in the time domain;
a number of symbols in the time domain for each TB;
a mapping relationship of TB index to symbol index, or
mapping a TB corresponding to the second codeword according to the mapping rule of the TB corresponding to the first codeword in same time-frequency resource.

12. The method according to claim 9, wherein:
the control information is transmitted via at least one of the following:
a downlink control information (DCI),
a radio resource control (RRC) signaling,
a high layer signaling,
a MAC control element (CE), or
system information.

13. The method according to claim 1, wherein:
upon receiving all time-domain symbols of a TB in the n TBs, the second wireless device performs a TB level process on the all time-domain symbols without waiting for receiving any other TB in the n TBs, wherein the TB level process comprises at least one of the following: a de-mapping process, a de-interleaving process, a de-modulating process, a de-coding process, or a process of delivering to a higher layer.

14. The method according to claim 9, further comprising:
receiving, by the second wireless device, the control information from the first wireless device;
processing, by the second wireless device, the set of TBs based on the control information by at least one of the following:
receiving data from the first wireless device based on the control information from the first wireless device;
sending data to the first wireless device based on the control information from the first wireless device;
sending data to a third wireless device based on the control information from the first wireless device; or
receiving data from the third wireless device based on the control information from the first wireless device.

15. The method according to claim 14, further comprising:
in response to receiving the data from the first wireless device, sending, by the second wireless device, feedback information to the first wireless device by at least one of the following:
sending the feedback information separately for each TB in the n TBs;
sending the feedback information together for the n TBs;
sending the feedback information for each code block (CB) in the n TBs; or
sending the feedback information for each code block group (CBG) in the n TBs.

16. (canceled)

17. The method according to claim 15, further comprising:
in response to the feedback information being same for each TB in the n TBs, sending the feedback information comprising a feedback indication for the n TBs, wherein:
in response to each TB in the n TBs being received successfully, the feedback information comprises an acknowledgement (ACK) indication indicating each TB in the n TBs being received successfully; and
in response to each TB in the n TBs being received unsuccessfully, the feedback information comprises a NAK indication indicating each TB in the n TBs being received unsuccessfully.

18. The method according to claim 1, wherein:
the first wireless device is configured to schedule transmission of the set of TBs, and the first wireless device comprises at least one of the following:
a base station;
a MAC layer in a wireless device;
a scheduling unit;
a user equipment (UE);
an on-board unit (OBU);
a road-side unit (RSU); or
an integrated access and backhaul (IAB) node.

19. The method according to claim 1, wherein:
the second wireless device is configured to receive transmission of the set of TBs, and the second wireless device comprises at least one of the following:
a user equipment (UE); or
an integrated access and backhaul (IAB) node.

20. The method according to claim 14, wherein:
the third wireless device is configured to receive or send transmission of the set of TBs, and the third wireless device comprises at least one of the following:
a user equipment (UE); or
an integrated access and backhaul (IAB) node.

21. (canceled)

22. (canceled)

23. (canceled)

24. (canceled)

25. (canceled)

26. (canceled)

27. (canceled)

28. (canceled)

29. (canceled)

30. A wireless communications apparatus comprising:
a memory operable to store computer-readable instructions; and
a processor circuitry operable to read the computer-readable instructions, the processor circuitry when executing the computer-readable instructions is configured to:
transmit a set of transport blocks (TBs) between a first wireless device and a second wireless device by:
map the set of TBs in a resource space comprising a time unit in a time domain and a frequency unit in a frequency domain, wherein:
each TB mapped to a same codeword in the set of TBs is separated in time domain;
the set of TBs comprises n TBs mapped to the same codeword, and n is an integer larger than 1; and
each TB in the set of TBs is capable of being packaged separately at a transmitting end, and capable of being delivered separately to an upper layer at a receiving end.

31. (canceled)
